(19) United States
(12) Patent Application Publication
(10) Pub. No.: US 2024/0229401 A1
(43) Pub. Date: Jul. 11, 2024

(54) CLAMPING SYTEMS, METHODS, AND APPARATUS FOR DRIVING CAISSONS INTO THE EARTH

(71) Applicant: AMERICAN PILEDRIVING EQUIPMENT, INC., Kent, WA (US)

(72) Inventor: Steven N. Cress, Renton, WA (US)

(73) Assignee: AMERICAN PILEDRIVING EQUIPMENT, INC., Kent, WA (US)

(21) Appl. No.: 18/402,460

(22) Filed: Jan. 2, 2024

Related U.S. Application Data
(60) Provisional application No. 63/478,476, filed on Jan. 4, 2023.

(51) Int. Cl. E02D 7/18; F16B 2/12

(52) U.S. Cl. CPC E02D 7/18; F16B 2/12

(57) ABSTRACT

An apparatus for attaching a caisson to a device for inserting and/or extracting the caisson. The apparatus comprises three beams. A first beam is relatively long and is normally connected to a vibratory device such that its longitudinal axis is orthogonal to the lengthwise axis of the vibratory device. The second and third beams are relatively short and are connected to the vibratory device such their longitudinal axes are parallel to the lengthwise axis of the vibratory device. Four clamp assemblies are mounted on the beams to fix the beams onto the caisson. A flange on the first beam may be widened at at least a middle portion thereof to stiffen the beam and allow the beam to be securely connected to the vibratory device. The first beam may also be used with its longitudinal axis parallel to the lengthwise axis of the vibratory device.

### RELATED APPLICATIONS

This application (Attorney's Ref. No. P220467) claims benefit of U.S. Provisional Application Ser. No. 63/478,476 filed Jan. 4, 2023, the contents of which are incorporated herein by reference.

### TECHNICAL FIELD

The present invention relates to clamp assemblies that allow vibratory devices to be attached to elongate members and, more particularly, such clamp assemblies that are adapted to connect a vibratory device to a caisson to allow the caisson to be driven into the earth.

### BACKGROUND OF THE INVENTION

In the construction industry, it is often necessary to insert pipe-like bodies into the earth. Such pipe like bodies are referred to as caissons in most situations and often as casings in the context of a pipe that is inserted into the earth during drilling operations.

As examples, caissons are inserted into the earth during new construction as part of a foundation for a structure; caissons are also commonly driven under a bridge or the like when providing additional structural resistance to earthquake damage. Casings are employed when drilling a hole to prevent the earth from collapsing into the hole as it is drilled.

In this application, the term “caisson” will be used to refer to any pipe like body that is driven into the earth, including the casings used in drilling operations.

To insert a caisson into the earth, a large driving force must be applied thereto. Often, vibratory devices are employed to introduce a vibratory force along the axis of the caisson during the driving process. The combination of a static driving force with a dynamic vibratory force is usually sufficient to overcome the earth's resistance and allow the caisson to be inserted therein.

A clamping assembly must be provided to allow vibratory forces to be effectively transmitted to the caisson. Such clamping assemblies have heretofore normally been adapted to engage the upper end of the caisson. In addition, as described in U.S. Pat. No. 5,544,979, clamp assemblies also exist that grip the side of the caisson as it is being driven into the earth.

The present invention relates to clamp assemblies that engage the upper end of the caisson. Normally, such clamp assemblies comprise a cast beam having individual clamp assemblies movably mounted on each end thereof. A vibratory device is bolted to an upper surface of the beam. The beam is then arranged above the caisson upper end and lowered such that opposing portions of the caisson upper end are received between gripping members of the clamp assemblies. The clamp assemblies are then actuated such that the gripping members grip the caisson upper end and thus fix the caisson relative to the vibratory device.

The vibratory device is then operated to create a vibratory force that, in combination with the weight of the vibratory device, clamping assembly, and caisson, drives the caisson into the earth.

This arrangement usually works well with caissons of relatively small diameter. With larger caisson diameters, however, the vibratory forces often cause walls of the caisson to vibrate, or diaphragm, especially under hard soil conditions. This diaphragming of the caisson absorbs the vibratory driving forces, preventing the caisson from being driven into the earth and oftentimes resulting in damage to the caisson. At a minimum, diaphragming requires that the driving process be performed more slowly.

An undesirable side effect of diaphragming of the caisson is that the vibratory forces are transmitted laterally by the caisson walls into the adjacent soil instead of vertically through the caisson to the lower end thereof. In many situations, such as when the caisson is being inserted adjacent to a building or other structure, these laterally transmitted vibratory forces are highly undesirable because they might unduly stress the adjacent structure.

The most common method of overcoming the problem of diaphragming is simply to increase the wall thickness of the caisson. The thicker caisson wall results in a more rigid caisson that resists diaphragming and can therefore be more easily driven into the earth.

Caissons with thicker walls are significantly more expensive, however, and U.S. Pat. No. 5,653,556 discloses apparatus and methods for driving caisson assemblies into the earth that allow the use of thin walled caissons under more circumstances.

The need, however, exists for improved clamp systems and methods of driving thin walled caissons during vibratory driving.

### SUMMARY OF THE INVENTION

The present invention may be embodied as a clamp structure for operatively connecting a vibratory device to a caisson. In this embodiment, the clamp structure comprises a primary beam structure comprising first, second, and third primary beams, a secondary beam, and a plurality of clamp assemblies. The secondary beam is operatively connected to the first and second primary beams. Each of the plurality clamp assemblies is supported by one of the first, second, and third primary beams.

The present invention may also be embodied as a method of operatively connecting a vibratory device to a caisson comprising the following steps. A primary beam structure comprising first, second, and third primary beams is provided. A secondary beam is provided. A plurality of clamp assemblies is provided. The secondary beam is operatively connected to the first and second primary beams. Each of the plurality clamp assemblies is supported from one of the first, second, and third primary beams. The clamp assemblies are operated such that locations of each the clamp assemblies are fixed relative to the primary beam structure and to the caisson.

The present invention may also be embodied as a drive system for driving a caisson comprising a primary beam structure comprising first, second, and third primary beams, a secondary beam, a plurality of clamp assemblies, and a vibratory device. The secondary beam is operatively connected to the first and second primary beams. Each of the plurality clamp assemblies is supported by one of the first, second, and third primary beams. The secondary beam is operatively connected to the vibratory device.

### BRIEF DESCRIPTION OF THE DRAWINGS

FIG. 1 is a perspective view depicting a first example clamping assembly of the present invention being used to connect a vibratory device to a caisson to be driven using the vibratory device;

FIG. 2 is a perspective view of a secondary beam of the first example clamping assembly;

FIG. 3 is a side elevation view illustrating a primary beam structure and a secondary beam of the first example clamping assembly;

FIG. 4 is a top plan view illustrating the primary beam structure and the secondary beam;

FIG. 5 is a top plan view illustrating a secondary beam;

FIG. 6 is a side view illustrating a secondary beam; and

FIG. 7 is a cross section of a secondary beam taken along Lines 7-7 in FIG. 6.

### DETAILED DESCRIPTION

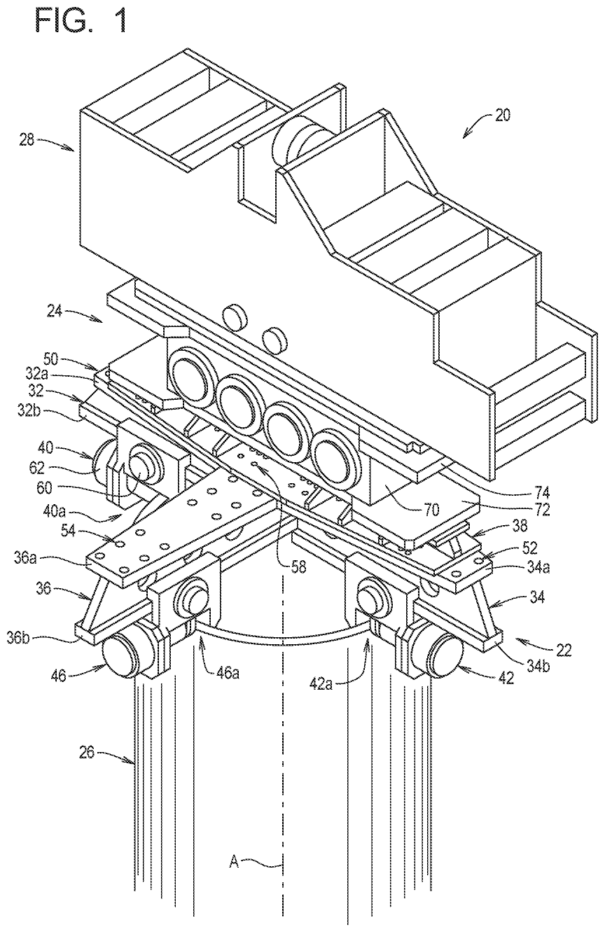

Referring now to the drawings, depicted at 20 in FIG. 1 is a drive system employing a clamp structure 22 constructed in accordance with, and embodying, the principles of the present invention. The clamp structure 22 secures a vibratory device 24 to a caisson 26. The vibratory device 24 itself is connected to a suppresser unit 28.

In operation, the suppresser unit 28 is connected to a cable suspended by a crane in a manner that is well known in the art. The vibratory device 24 generates vertical vibratory loads that are imparted to the caisson 26 through the clamp structure 22 along a vibratory axis A as shown in FIG. 1. A static driving force is also applied by the weight of the entire driving device 20. The suppresser unit 28 substantially isolates the cable and crane from the vertical vibratory forces generated by the vibratory device 24.

Of the foregoing components, the vibratory device 24, caisson 26, and suppresser unit 28 are all known in the art and will not be described in detail herein.

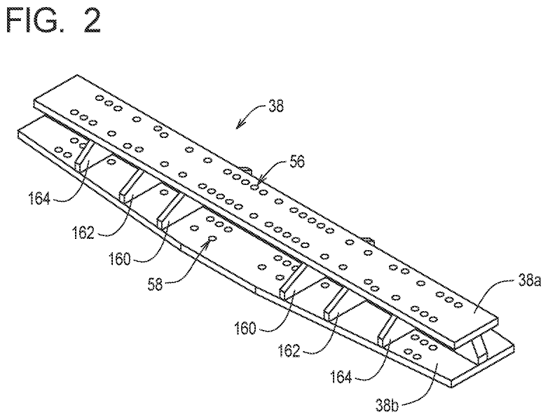

FIGS. 1-4 illustrate that the clamp structure 22 comprises a primary beam structure 30 comprising first, second, and third primary beams 32, 34, and 36, a secondary beam 38, and first through fourth clamp assemblies 40, 42, 44, and 46.

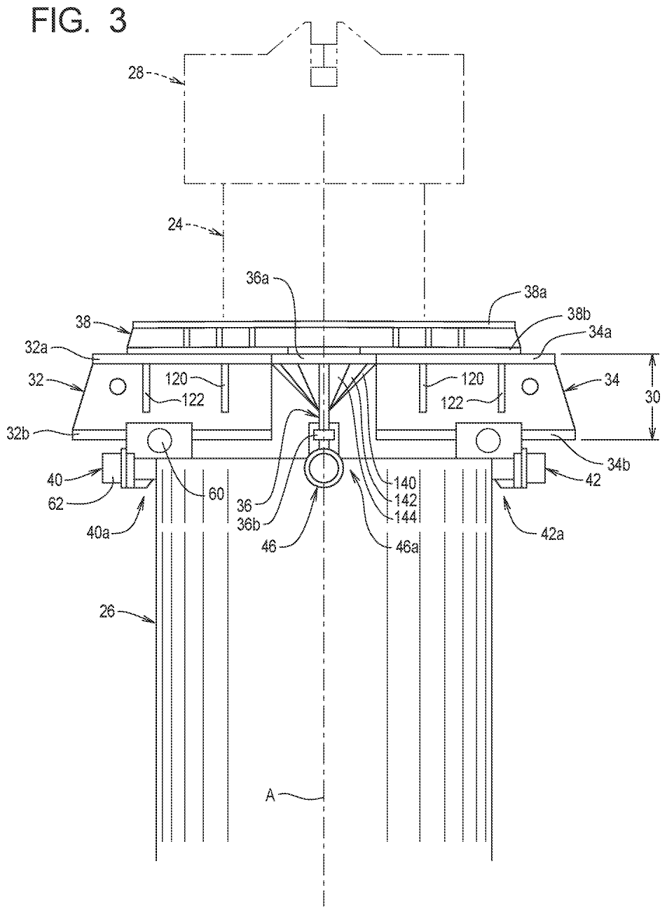

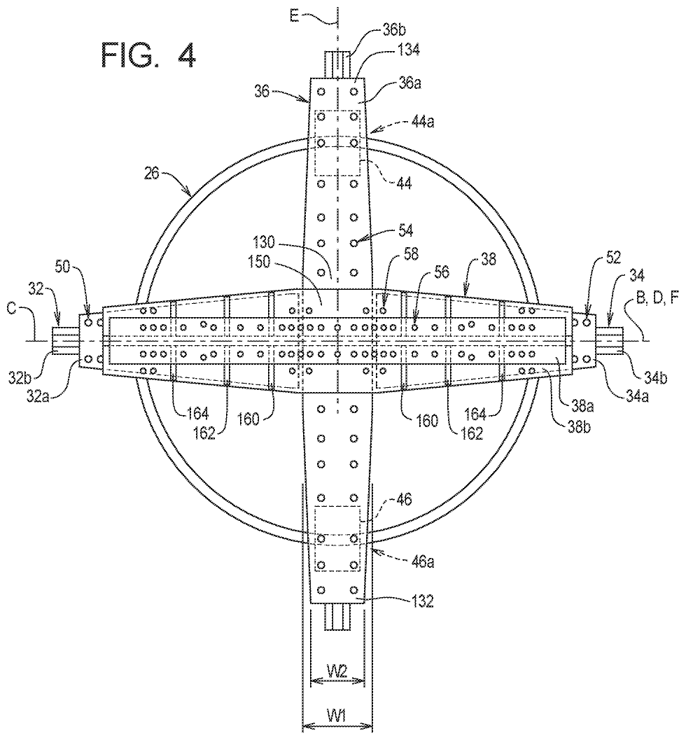

In the following discussion, the following axes are illustrated in FIGS. 3 and FIG. 4 to clarify certain features of the present invention. A vibratory axis A, which is normally vertical, substantially coincides with the longitudinal axis of the caisson 26. The example vibratory device 24 is generally elongate in overall configuration and has a lengthwise axis B that is orthogonal to the vibratory axis A. The beams 32-38 are also elongate, with the first primary beam 32 having a first beam axis C, the second primary beam 34 having a second beam axis D, the third primary beam 36 having a third beam axis E, and the secondary beam 38 having a fourth beam axis F.

The example beams 32-38 are substantially in the form of I-beams, each having upper and lower flanges. In particular, a first upper flange 32a and first lower flange 32b are formed on the first primary beam 32, a second upper flange 34a and second lower flange 34b are formed on the second primary beam 34, a third upper flange 36a and third lower flange 36b are formed on the third primary beam 36, and a fourth upper flange 38a and fourth lower flange 38b are formed on the secondary beam 38. Beam structures other than I-beams that satisfy the structural requirements of transmitting vibratory forces from the vibratory device 24 to the caisson 26 may be used in addition or instead.

First and second hole sets 50 and 52 are formed in the upper flanges 32a and 34a of the primary beams 32 and 34, respectively. A third hole set 54 is formed in the upper flange 36a of the third primary beam 36. A fourth hole set 56 is formed in the upper flange 38a of the example secondary beam 38, and a fifth hole set 58 is formed in the lower flange 38b of the example secondary beam 38. The holes forming the hole sets 50, 52, 54, 56, and 58 are sized and dimensioned to receive bolt assemblies (not shown for clarity) for the purpose of detachably attaching components in which the holes are formed (e.g., beams 32-38, vibratory member 24). The bolt assemblies are well-known and typically comprise a bolt having a head and a shaft at least a portion of which is threaded and a threaded nut. The shaft extends through aligned holes in parts to be detachably attached, and the nut is threaded onto the shaft to clamp or secure together the two parts to be detachably attached. The exact size and location of the holes in the first, second, third, fourth, and fifth hole sets 50-58 and of the bolt assemblies extending through these holes are not critical so long as loads are effectively transferred between the beams 32, 34, 36, and/or 38 and/or the vibratory device 24 as generally described below.

As will be described in further detail below, in a first mode of operation, the example first and second hole sets 50 and 52 align with at least some of the holes in the fifth hole set 58 to allow the secondary beam 38 to be detachably attached using bolt assemblies to the first and second primary beams 32 and 34. In the first mode, at least some of the holes in the example third hole set 54 align with at least some of the holes in the fifth hole set 58 to allow the secondary beam 38 to be detachably attached, using bolt assemblies, to the third primary beam 36. The example third hole set 54 is configured to allow the vibratory device 24 to be detachably attached using bolt assemblies to the secondary beam 38 in the first mode. In the first mode, the secondary beam 38 may be connected by bolts to the third primary beam 36. Optionally, the secondary beam 38 may be connected by bolts only to the first and second primary beams 32 and 34 and not to the third primary beam 36.

The example third hole set 54 is further configured such that at least some of the holes thereof align with at least some of the holes in the fifth hole set 58 to detachably attach the third primary beam 36 to the vibratory device using bolt assemblies in a second mode of operation. In this second mode of operation, the first and second primary beams 32 and 34 and secondary beam 38 are not used.

As perhaps best shown in FIG. 1 and FIG. 4, the example clamp assemblies 40-46 engage and are supported by the lower flanges 32b, 34b, and 36b such that these clamp assemblies 40-46 can slide along the beam axes C, D, and E but do not move relative to the beams 32-36 along the vibratory axis A. In the example drive system 20, the first clamp assembly 40 is attached to the first primary beam 32, the second clamp assembly 42 is attached to the second primary beam 34, and the third and fourth clamp assemblies 44 and 46 are attached to the third primary beam 36. In the second mode of operation, the third and fourth clamp assemblies 44 and 46 are attached to the third primary beam 36 and the first and second clamp assemblies 40 and 42 are not used.

The example clamp assemblies 40-46 are identical, well known in the art, and are functionally interchangeable. But clamp assemblies of two or more different designs may be used. Given that the example clamp assemblies 40-46 are identical, only the first example clamp assembly 40 will be described herein as helpful to an understanding of the operation of the present invention. As an example, the first clamp assembly 40 comprises a first hydraulic cylinder 60 for securing the clamp assembly 40 relative to the first primary beam 32 and a second hydraulic cylinder 62 for securing the clamp assembly 40 to the caisson 26. The example clamp assemblies 40 and 42 may thus be configured to selectively fix, in the first mode, a location of the clamp assemblies 40 and 42 relative to the first and second primary beams 32 and 34, respectively, and to the caisson 26. The example clamp assemblies 44 and 46 may similarly be configured to selectively fix, in the second and third modes, a location of the clamp assemblies 44 and 46 relative to the third primary beam 36 and to the caisson 26.

Referring for a moment back to FIG. 1, the example vibratory device 24 comprises a housing 70, a base plate 72, and an upper plate 74. The base plate 72 and upper plate 74 are rigidly connected to the housing 70 by bolt assemblies, welding, or the like. As is conventional, the example housing 70 is adapted to be operatively connected to and supported by the suppressor unit 28, and the example base plate 72 is adapted to be rigidly connected to the clamp structure 22 using bolt assemblies as generally described above.

The use and arrangement of the beams 32-38 relative to the caisson 26 and vibratory device 24 is depicted in FIGS. 1, 3, and 4. In particular, the primary beam structure 30 is configured such that the lengthwise axes C and D of the first and second primary beams 32 and 34 are aligned and parallel to the lengthwise axis B of the vibratory device 24. When the primary beam structure 30 is formed, a lengthwise axis E of the example third primary beam 36 is substantially orthogonal to the lengthwise axis B of the vibratory device 24. FIGS. 1, 3, and 4 illustrate that, assembled as described above, the primary beam structure 30 is arranged in a substantially cruciform shape during use.

FIGS. 1, 3, and 4 illustrate that the secondary beam 38 is, in the first mode, combined with the of the example primary beam structure 30 such that the lengthwise axis F of the secondary beam 38 is substantially parallel to the lengthwise axis B of the vibratory device 24. When assembled onto the primary beam structure 30 by bolting or the like, the secondary beam 38 extends along (e.g., substantially parallel to) the first primary beam 32, across (e.g., substantially perpendicular to) the third primary beam 36, and along (e.g., substantially parallel to) the second primary beam 34. The secondary beam 38 thus rigidifies the primary beam structure 30 by joining the separate first and second primary beams 32 and 34 while also extending across and over the third primary beam 36. The use of the secondary beam 38 thus rigidifies the clamp structure 22 and allows more effective transfer of static and/or vibratory loads from the vibratory device 24 to the caisson 26.

FIGS. 1 and 3 further illustrate that this cruciform shape results in the clamp structure 22 engaging the caisson 26 at four different gripping locations 40a, 42a, 44a, and 46a associated with the clamp assemblies 40, 42, 44, and 46, respectively. Additionally, with the example clamp structure 22, these clamping locations 40a, 42a, 44a, and 46a are all spaced at substantially equal 90 degree intervals from each other. This even spacing of the clamping locations 40a, 42a, 44a and 46a is not essential but may be desirable to obtain more even distribution of static and/or vibratory loads being applied to the caisson 26.

FIGS. 1, 3, and 4 also show that a length of the third primary beam 36 is slightly more than twice the total of the lengths of the first and second primary beams 32 and 36 and that the example secondary beam 38 is slightly shorter than the third primary beam 36.

As best shown in FIG. 3, the example first and second primary beams 32 and 34 comprises a plurality of first brace members 120 and a plurality of second brace members 122. The brace members 120 and 122 are configured to brace the first and second upper flanges 32a and 34a and thereby rigidify the first and second primary beams 32 and 34. The example brace members 120 and 122 have the same cross-sectional area but may differ in cross-sectional area.

As shown in FIGS. 1 and 4, the third upper flange 36a of the third primary beam 36 is not of uniform size. As shown in FIG. 4, a width W1 of the third upper flange 36a at a central portion 130 is greater than a width W2 of the first upper flange 36a at end portions 132 and 134. The widths W1 and W2 are measured in a direction orthogonal the third longitudinal axis E of the third primary beam 36 and to the driving axis A. Further, as shown in FIG. 4, a shape (in top plan view) of a perimeter of the bottom flange 38b of the secondary beam 38 is substantially the same as a composite shape generally follows the perimeters of the top flanges 32a and 34a of the first and second primary beams 32 and 34 and extends laterally across the central portion 130 of the third primary beam 36. Further, the overall shape of the perimeter of the example bottom flange 38b is slightly wider and slightly shorter than the composite shape formed relative to the first, second, and third primary beams 32, 34, and 36 when combined to form the primary beam structure 30. In any event, the exact relative lengths and widths of the primary beams 32, 34, 36 and the secondary beam 38 may not be critical for a particular implementation of the present invention, but the exact relative lengths and widths of the example primary beams 32, 34, 36 and the example secondary beam 38 are predetermined to optimize transmission of static and/or vibratory loads from the vibratory device 24 to the caisson 26.

The wider central portion 130 provides a larger surface area for attachment to the secondary beam 38 that allows more bolts to be employed to attach the third primary beam 36 to the secondary beam 38. This wider central portion 130 also rigidifies the third primary beam 36 to accommodate the additional loads that must be transferred in the smaller contact area resulting from the transverse relationship between the longitudinal axes the third primary beam 36 and the secondary beam 38.

FIGS. 3 and 4 further illustrate that the example third primary beam 36 comprises a plurality of brace members 140, 142, and 144 configured to brace the third upper flange 36a. The example third brace members 144 adjacent to the end portions 132 and 134 of the third upper flange 36a are smaller in cross-sectional area than the example brace members 140 adjacent to the central portion 130. The example brace members 142 between the wider central portion 130 and the end portions 132 and 134 are larger in cross-sectional area than the example brace members 144 and smaller in cross-sectional area than the example brace members 140.

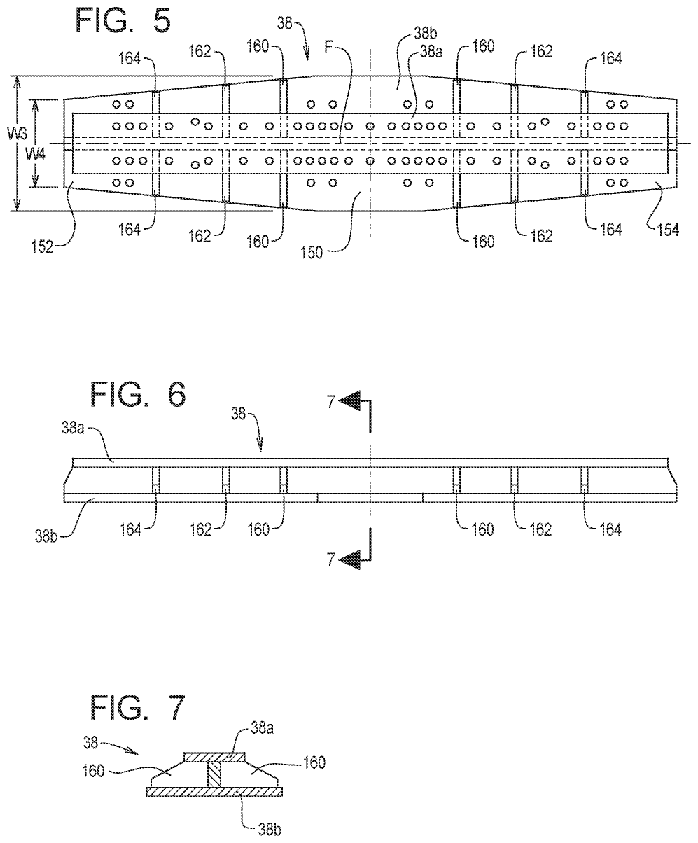

Turning now to the secondary beam 38, FIGS. 4 and 5 illustrate that the fourth lower upper flange 38b of the secondary beam 38 is also not of uniform size. In particular, a width W3 of the fourth lower flange 38b at a central portion 150 greater than a width W4 of the fourth lower flange 38b at end portions 152 and 154. The widths W3 and W4 are measured in a direction orthogonal the fourth longitudinal axis F of the secondary beam 38.

The wider central portion 150 provides a larger surface area that allows more bolt assemblies to be employed to attach the secondary beam 38 to first, second and third primary beams 32, 34 and 36. This wider central portion 150 also rigidifies the central portion 70 of the secondary beam 38 to accommodate the additional loads that must be transferred in the smaller contact area resulting from the fact that the secondary beam 38 is transverse to the longitudinal axis of vibratory device 24. This configuration of the example secondary beam 38 provides a stable, rigid, and balanced connection of the vibratory device 24 to the caisson 26, but other configurations may be used.

As shown in FIGS. 4-7, the example secondary beam 38 comprises a plurality of first, second, and third brace members 160, 162, and 164 configured to brace the fourth upper flange 38a. The example third brace members 164 adjacent to the end portions 152 and 154 of the upper flange 38a are smaller in cross-sectional area than the example brace members 160 adjacent to the central portion 150. The example brace members 162 between the wider central portion 150 and the end portions 152 and 154 are larger in cross-sectional area than the example brace members 164 and smaller than the example brace members 160.

The example primary beam structure 30 thus comprises three separate beams 32, 34, and 36. Each of these example beams 32, 34, and 36 is or may be a cast I-beam that is relatively easy to fabricate. The example secondary beam 38 also is or may be a cast I-beam that is relatively easy to fabricate. These separate beams 32, 34, 36, and 38 are also relatively easy to store and handle when not in use or during assembly for use.

The clamp structure 22 described above is used generally as follows. Initially, the vibratory device 24 and suppresser 28 are obtained as a unit or assembled together so that the suppresser 28 is rigidly connected to the upper plate 74 of the vibratory device 24. The secondary beam 38 is then bolted to the first and second primary beams 32 and 34, to the base plate 72 of the vibratory device 24, and, optionally, to the third primary beam 36, such that the lengthwise axes C and D of the first and second primary beams 32 and 34 and the lengthwise axis F of the secondary beam 38 are parallel to the lengthwise axis B of the vibratory device 24 and a lengthwise axis E of the third primary beam is orthogonal to the lengthwise axis B of the vibratory device 24. The exact sequence of assembly operations described above is not critical to any given implementation of the present invention and may be varied depending on a particular situation. The entire assembly 20 is then suspended above the caisson 26.

At this point, or earlier if the diameter of the caisson 26 is known, the clamp assemblies 40-46 are arranged on their respective beams such that they are substantially symmetrically arranged around the vibratory axis A and spaced from each other a distance suitable to accommodate the diameter of the caisson 26. The entire driving device 20 is then lowered to a position where the clamp assemblies 40-46 straddle the engaging portions 40a-46a relative to the caisson 26. The second hydraulic cylinders 62 are then operated to lock the clamp assemblies 40-46 relative to the caisson 26. The first hydraulic cylinders 60 are then actuated to lock the clamp members 40-46 relative to the first through third primary beams 32-36.

The vibratory device 24 is now rigidly connected to the four gripping portions 40a-46a through the clamp structure 22. The vibratory device may then be actuated to apply a vibratory load to the caisson 26 for the purpose of driving or pulling the caisson 26.

In addition to the first mode of operation shown above with respect to FIGS. 1-4, the clamp structure 22 has the additional flexibility to be used, in the second mode with two points of contact, by removing the first and second primary beams 32 and 34 and the secondary beam 38. In this second mode of operation, the vibratory device 24 is directly connected to the third primary beam 36. In this second mode, the longitudinal axis E of the third primary beam 36 is arranged substantially parallel to the longitudinal axis B of the vibratory device 24.

The example clamp structure 22 may additional be operated in a third mode comprising the primary beam structure 30 and omitting the secondary beam 38. In this third mode, the clamp structure 22 engages the caisson 26 at four locations (e.g., the locations 40a, 42a, 44a, and 46a) but omits the weight and cost of using the secondary beam 38.

What is claimed is:

1. A clamp structure for operatively connecting a vibratory device to a caisson, the clamp structure comprising:
a primary beam structure comprising first, second, and third primary beams;
a secondary beam; and
a plurality of clamp assemblies; wherein
the secondary beam is operatively connected to the first and second beams; and
each of the plurality clamp assemblies is supported by one of the first, second, and third primary beams.

2. A clamp structure as recited in claim 1, in which the secondary beam is further operatively connected to the third primary beam.

3. A clamp structure as recited in claim 1, in which:
the plurality of clamp assemblies comprises first, second, third, and fourth clamp assemblies;
the first clamp is supported by the first primary beam;
the second clamp is supported by the second primary beam; and
the third and fourth clamp assemblies are supported by the third primary beam.

4. A clamp structure as recited in claim 1, in which:
the first primary beam defines a first longitudinal axis;
the second primary beam defines a second longitudinal axis;
the third primary beam defines a third longitudinal axis;
the secondary beam defines a fourth longitudinal axis;
when the secondary beam is operatively connected to the first and second beams, the fourth longitudinal axis is substantially parallel to the first and second axes and substantially perpendicular to the third longitudinal axis.

5. A method of operatively connecting a vibratory device to a caisson comprising the steps of:
providing a primary beam structure comprising first, second, and third primary beams;
providing a secondary beam; and
providing a plurality of clamp assemblies; wherein
operatively connecting the secondary beam to the first and second beams; and
supporting each of the plurality clamp assemblies from one of the first, second, and third primary beams; and
operating the clamp assemblies such that locations of each the clamp assemblies are fixed relative to the primary beam structure and to the caisson.

6. A method as recited in claim 5, further comprising the step of operatively connecting the secondary beam to the third primary beam.

7. A method as recited in claim 5, in which:
the step of providing the plurality of clamp assemblies comprises the step of providing first, second, third, and fourth clamp assemblies;
the step of supporting each of the plurality of clamp assemblies from the first, second, and third primary beams comprises the steps of
supporting the first clamp from the first primary beam;
supporting the second clamp from the second primary beam; and
supporting the third and fourth clamp assemblies from the third primary beam.

8. A clamp structure as recited in claim 5, in which:
the first primary beam defines a first longitudinal axis;
the second primary beam defines a second longitudinal axis;
the third primary beam defines a third longitudinal axis;
the secondary beam defines a fourth longitudinal axis; and
when the secondary beam is operatively connected to the first and second beams, the fourth longitudinal axis is substantially parallel to the first and second axes and substantially perpendicular to the third longitudinal axis.

9. A drive system for driving a caisson, the drive system comprising:
a primary beam structure comprising first, second, and third primary beams;
a secondary beam;
a plurality of clamp assemblies; and
a vibratory device; wherein
the secondary beam is operatively connected to the first and second beams;
each of the plurality clamp assemblies is supported by one of the first, second, and third primary beams; and
the secondary beam is operatively connected to the vibratory device.

10. A clamp structure as recited in claim 9, in which the secondary beam is further operatively connected to the third primary beam.

11. A clamp structure as recited in claim 9, in which:
the plurality of clamp assemblies comprises first, second, third, and fourth clamp assemblies;
the first clamp is supported by the first primary beam;
the second clamp is supported by the second primary beam; and
the third and fourth clamp assemblies are supported by the third primary beam.

12. A clamp structure as recited in claim 9, in which:
the first primary beam defines a first longitudinal axis;
the second primary beam defines a second longitudinal axis;
the third primary beam defines a third longitudinal axis;
the secondary beam defines a fourth longitudinal axis;
when the secondary beam is operatively connected to the first and second beams, the fourth longitudinal axis is substantially parallel to the first and second axes and substantially perpendicular to the third longitudinal axis.

13. A clamp structure as recited in claim 9, further comprising a suppressor operatively connected to the vibratory device.
